(19) United States
(12) Patent Application Publication
(10) Pub. No.: US 2025/0203286 A1
(43) Pub. Date: Jun. 19, 2025

(54) ACOUSTIC SYSTEM AND SIGNAL PROCESSING METHOD

(71) Applicant: SHENZHEN SHOKZ CO., LTD., Shenzhen (CN)

(72) Inventors: Bocheng LI, Shenzhen (CN); Chenyang WU, Shenzhen (CN)

(73) Assignee: SHENZHEN SHOKZ CO., LTD., Shenzhen (CN)

(21) Appl. No.: 19/069,155

(22) Filed: Mar. 3, 2025

Related U.S. Application Data
(63) Continuation of application No. PCT/CN2023/096295, filed on May 25, 2023.

(51) Int. Cl. H04R 3/04; H04R 29/00

(52) U.S. Cl. CPC H04R 3/04; H04R 29/001; H04R 2430/01

(57) ABSTRACT

An acoustic system and a signal processing method are provided. In the acoustic system, a pickup component converts an ambient sound into a first audio signal. The ambient sound includes a first sound from a speaker and a second sound from a target sound source. A first peripheral circuit connects a signal processing circuit and the speaker, and there is a reference signal pickup point in the first peripheral circuit. A second peripheral circuit connects the reference signal pickup point and the signal processing circuit. During operation, a first reference signal is obtained from the reference signal pickup point and a second reference signal is output to the signal processing circuit, so that the signal processing circuit reduces the component corresponding to the first sound in the first audio signal based on the second reference signal to obtain a target signal.

### RELATED APPLICATIONS

This application is a continuation application of PCT application No. PCT/CN2023/096295, filed on May 25, 2023, and the content of which is incorporated herein by reference in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to the field of acoustic technology, and in particular to an acoustic system and a signal processing method.

### BACKGROUND

Some acoustic systems include both speakers and sound sensors. These acoustic systems often face the issue of acoustic feedback. Acoustic feedback refers to a situation where a sound sensor picks up ambient sound to obtain a pickup signal, which is then processed and played through the speaker. The sound emitted by the speaker is subsequently picked up again by the sound sensor, forming a closed-loop circuit of “speaker→sound sensor→speaker.” In such acoustic systems, the sound picked up by the sound sensor from the speaker can be referred to as feedback sound. The presence of feedback sound leads to several issues in the acoustic system. For example, it may cause howling and can also limit the maximum achievable forward gain of the acoustic system. Therefore, it is necessary to provide an acoustic solution that can reduce or eliminate feedback components.

### SUMMARY

This disclosure provides an acoustic system that can reduce or eliminate feedback sound, thereby avoiding issues such as howling caused by feedback sound and improving the maximum forward gain that the acoustic system can achieve.

In a first aspect, this disclosure provides an acoustic system, comprising: a speaker, which converts a driving signal into a first sound during operation; a pickup component, which converts an ambient sound into a first audio signal during operation, the ambient sound comprising the first sound and a second sound from a target sound source; a signal processing circuit, connected to the pickup component; a first peripheral circuit, comprising an input port and an output port, the output port being connected to the speaker, the first peripheral circuit comprising a reference signal pickup point; and a second peripheral circuit, connecting the reference signal pickup point and the signal processing circuit, where the first peripheral circuit, during operation, obtains a second audio signal through the input port, converts the second audio signal into a driving signal, and sends the driving signal to the speaker through the output port; the second peripheral circuit, during operation, obtains a first reference signal from the reference signal pickup point and outputs a second reference signal to the signal processing circuit; and the signal processing circuit, during operation, reduces a signal component corresponding to the first sound in the first audio signal based on the second reference signal to obtain a target signal, and performs a target operation on the target signal.

In a second aspect, this disclosure provides a signal processing method, comprising, by a signal processing circuit in an acoustic system: obtaining a first audio signal, where the first audio signal is obtained by a pickup component in the acoustic system converting an ambient sound, the ambient sound comprises the first sound and a second sound, the first sound is a sound from a speaker in the acoustic system, and the second sound is a sound from a target sound source; obtaining a second reference signal, where the second reference signal is obtained by a second peripheral circuit in the acoustic system based on a first reference signal, the first reference signal is obtained by the second peripheral circuit from a reference signal pickup point of a first peripheral circuit in the acoustic system, and the first peripheral circuit is connected to the processing circuit and the speaker; reducing a signal component corresponding to the first sound in the first audio signal based on the second reference signal to obtain a target signal; and performing a target operation on the target signal.

From the above technical solutions, it can be seen that in the acoustic system and signal processing method provided in this disclosure, the pickup component in the acoustic system converts ambient sound into a first audio signal. The ambient sound includes a first sound from the speaker and a second sound from the target sound source. A first peripheral circuit connects the signal processing circuit and the speaker, and a reference signal pickup point is present in the first peripheral circuit. A second peripheral circuit connects the reference signal pickup point and the signal processing circuit. During operation, the first reference signal is obtained from the reference signal pickup point, and the second peripheral circuit outputs a second reference signal to the signal processing circuit. As a result, the signal processing circuit reduces the components in the first audio signal corresponding to the first sound based on the second reference signal to obtain a target signal. Since the feedback components in the target signal are reduced or eliminated, this approach can prevent or suppress howling in the acoustic system and also help improve the maximum achievable forward gain of the acoustic system.

Other functions of the acoustic system and signal processing method provided in this disclosure will be partially listed in the following description. The inventive aspects of the acoustic system and signal processing method provided in this disclosure can be fully explained through the practice or use of the methods, devices, and combinations described in the detailed examples below.

### BRIEF DESCRIPTION OF THE DRAWINGS

In order to more clearly illustrate the technical solutions in the embodiments of this disclosure, a brief introduction to the accompanying drawings required in the description of the embodiments is provided below. It is evident that the accompanying drawings described below are merely some exemplary embodiments of this disclosure. For a person skilled in the art, other drawings can also be obtained based on these drawings without creative effort.

FIG. 1 is a schematic diagram of an application scenario provided in some exemplary embodiments of this disclosure;

FIG. 2 is a schematic diagram of the principle of feedback sound elimination based on AFC technology;

FIG. 3A to 3C are schematic diagrams of a few acoustic systems provided in some exemplary embodiments of this disclosure;

FIG. 4A to 4C are schematic diagrams of a few positions of a reference signal pickup point in an acoustic system;

FIG. 5A to 5C are schematic diagrams showing the connection of K branch ports of a first peripheral circuit in an acoustic system;

FIG. 6A to 6D are schematic diagrams of a few other positions of a reference signal pickup point in an acoustic system;

FIG. 7 shows the test results of an acoustic system provided in some exemplary embodiments of this disclosure with respect to filtering performance;

FIG. 8 is a schematic diagram of the hardware structure of an acoustic system provided in some exemplary embodiments of this disclosure; and

FIG. 9 is a flowchart of a signal processing method provided in some exemplary embodiments of this disclosure.

### DETAILED DESCRIPTION

The following description provides specific application scenarios and requirements of this disclosure, with the aim of enabling a person skilled in the art to manufacture and use the content of this disclosure. For a person skilled in the art, various local modifications to the disclosed embodiments are apparent, and the general principles defined here can be applied to other embodiments and applications without departing from the spirit and scope of this disclosure. Therefore, this disclosure is not limited to the embodiments shown but is intended to cover the broadest scope consistent with the claims.

The terms used herein are for the purpose of describing specific example embodiments and are not meant to be restrictive. For example, unless otherwise explicitly stated in the context, the singular forms “a,” “an,” and “the” may also include the plural forms. When used in this disclosure, the terms “include,” “comprise,” and/or “contain” mean that the associated integer, step, operation, element, and/or component is present but do not exclude the presence of one or more other features, integers, steps, operations, elements, components, and/or groups, or the possibility of adding other features, integers, steps, operations, elements, components, and/or groups to the system/method.

Given the following description, these features and other features of the disclosure, as well as the operation and functionality of the related elements of the structure, and the combination and manufacturability of the parts, can be significantly improved. The accompanying drawings, which form part of this disclosure, are referenced for illustration. However, it should be clearly understood that the drawings are for illustration and description purposes only and are not intended to limit the scope of this disclosure. It should also be understood that the drawings are not drawn to scale.

The flowcharts used in this disclosure illustrate the operations of the system implementation according to some exemplary embodiments of this disclosure. It should be clearly understood that the operations in the flowcharts may not be implemented in a specific order. Instead, the operations may be performed in reverse order or concurrently. Additionally, one or more other operations may be added to the flowcharts, or one or more operations may be removed from them.

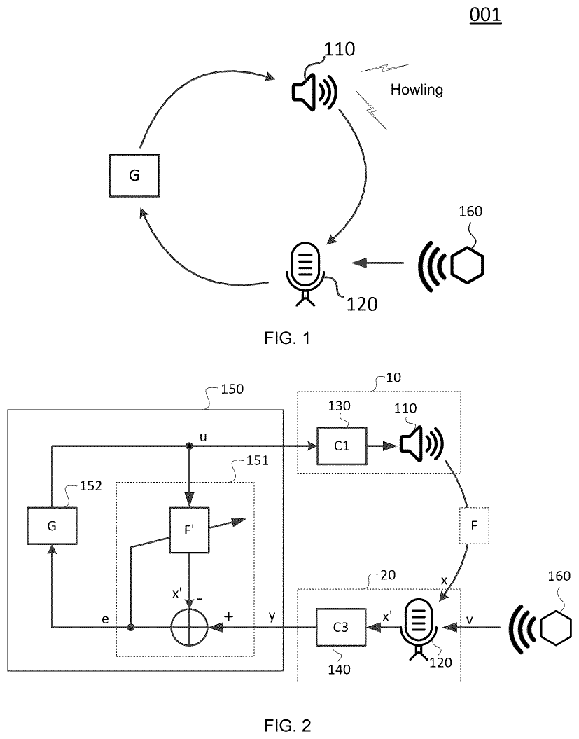

Before describing the specific embodiments of this disclosure, the application scenarios of this disclosure are introduced as follows. The technical solutions provided in this disclosure can be applied to scenarios where it is necessary to reduce or eliminate feedback sound. An example is provided below with reference to FIG. 1.

FIG. 1 is a schematic diagram of an application scenario provided in some exemplary embodiments of this disclosure. As shown in FIG. 1, application scenario 001 can be a sound amplification scenario, an assistive listening scenario, a hearing aid scenario, etc. In this scenario, the acoustic system may include a speaker 110 and a sound sensor 120. The sound sensor 120 collects ambient sound during operation. In this disclosure, ambient sound refers to the sound in the environment, meaning it can include sounds from all sound sources in the environment. During the sound pickup process of the sound sensor 120, if both the speaker 110 and the target sound source 160 are producing sound, the ambient sound collected by the sound sensor 120 includes both the sound from the target sound source 160 and the sound from the speaker 110. Furthermore, the signal collected by the sound sensor 120 is amplified by forward gain (G) and then transmitted to the speaker 110 to drive the speaker 110 to produce sound. This forms a closed-loop circuit in the acoustic system: “speaker→sound sensor→speaker.” In this case, when self-oscillation occurs at certain sound signal frequencies, howling may be generated. Such howling can cause discomfort to users and, if severe, may even damage components in the acoustic system. Additionally, the presence of howling also imposes limitations on the forward gain amplification factor of the acoustic system, thereby restricting the maximum forward gain that the acoustic system can achieve.

It should be noted that the application scenario shown in FIG. 1 is only one of the multiple applicable scenarios for this disclosure. The acoustic system provided by this disclosure can also be applied to other similar scenarios, which are not exhaustively listed in this disclosure. A person skilled in the art should understand that applying the solution provided in this disclosure to other usage scenarios also falls within the scope of protection of this disclosure.

In summary, the presence of feedback sound can lead to a series of issues in the acoustic system, including but not limited to howling and limitations on the maximum forward gain that the acoustic system can achieve.

In some exemplary embodiments, the acoustic system may adopt Acoustic Feedback Cancellation (AFC) technology to reduce or eliminate feedback sound. For ease of subsequent description, the principle of AFC technology is first introduced below with reference to FIG. 2.

FIG. 2 is a schematic diagram of the principle of feedback sound elimination based on AFC technology. As shown in FIG. 2, the acoustic system may include a sounding component 10, a pickup component 20, and a signal processing circuit 150.

The sounding component 10 is a component with a sound-producing function. The sounding component 10 may be connected to the output end of the signal processing circuit 150 and, during operation, receives a second audio signal u from the signal processing circuit 150 and converts it into sound for playback. Referring further to FIG. 2, the sounding component 10 may include a speaker 110 and a first peripheral circuit 130 (represented as C1 in the figure). The speaker 110 is a device used to convert electrical signals into sound, also referred to as an electroacoustic transducer. For example, the speaker 110 may be a loudspeaker. The first peripheral circuit 130 is connected between the output end of the signal processing circuit 150 and the speaker 110. The first peripheral circuit 130 may refer to all or part of the circuits between the output end of the signal processing circuit 150 and the speaker 110. The first peripheral circuit 130 processes the electrical signal output from the signal processing circuit 150 (i.e., the second audio signal u) to make it suitable for playback by the speaker 110.

For ease of description, the electrical signal processed by the first peripheral circuit 130 is referred to as the driving signal u′″ in the following text. The first peripheral circuit 130 may include at least one circuit element. The at least one circuit element may include, but is not limited to, operational amplifier components, power amplifier components, digital-to-analog converter components, filter components, modulator components, demodulator components, capacitors, resistors, inductors, chips, and other components.

It should be noted that the speaker 110 may be a device that produces sound based on at least one conduction method among gas, liquid, and solid conduction. The embodiments of this disclosure do not impose limitations on this aspect. The speaker 110 may be the loudspeaker itself or may include the loudspeaker along with its associated simple circuit components. The number of speakers 110 may be one or more. When there are multiple speakers 110, they may be arranged in an array. Additionally, when multiple speakers 110 are present, they may be connected to the signal processing circuit 150 through the same first peripheral circuit 130, or they may be connected to the signal processing circuit 150 through different first peripheral circuits 130.

The pickup component 20 is a component with a sound-picking function. The pickup component 20 may be connected to the input end of the signal processing circuit 150 and, during operation, picks up ambient sound to generate a first audio signal y, which is then sent to the signal processing circuit 150. Referring further to FIG. 2, the pickup component 20 may include a sound sensor 120 and a third peripheral circuit 140 (represented as C3 in the figure). The sound sensor 120 is a device used to pick up ambient sound and convert it into an electrical signal, also referred to as an acoustic-to-electric transducer. For example, the sound sensor 120 may be a microphone (MIC).

For ease of description, the electrical signal obtained by the sound sensor 120 through picking up ambient sound and converting it is referred to as the pickup signal y′. The third peripheral circuit 140 is connected between the sound sensor 120 and the input end of the signal processing circuit 150. The third peripheral circuit 140 may refer to all or part of the circuits between the sound sensor 120 and the input end of the signal processing circuit 150. The third peripheral circuit 140 processes the electrical signal picked up by the sound sensor 120 (i.e., the pickup signal y′), converts it into the first audio signal y, and sends the first audio signal y to the signal processing circuit 150. The third peripheral circuit 140 may include at least one circuit element. The at least one circuit element may include, but is not limited to, power amplifier components, operational amplifier components, analog-to-digital converter components, filter components, modulator components, demodulator components, capacitors, resistors, inductors, chips, and other components.

It should be noted that the sound sensor 120 may be a device that picks up sound based on at least one conduction method among gas, liquid, and solid conduction. This disclosure does not impose limitations on this aspect. The sound sensor 120 may be the microphone (MIC) itself or may include the MIC along with its associated simple circuit components. The number of sound sensors 120 may be one or more. When there are multiple sound sensors 120, they may be arranged in an array. Additionally, when multiple sound sensors 120 are present, they may be connected to the signal processing circuit 150 through the same third peripheral circuit 140, or they may be connected to the signal processing circuit 150 through different third peripheral circuits 140.

Referring further to FIG. 2, the working process of the acoustic system is as follows: the sounding component 10 receives a second audio signal u from the signal processing circuit 150 and converts it into a first sound. The target sound source 160 emits a second sound. The target sound source 160 refers to sound sources in the environment other than the sounding component 10. For example, the target sound source 160 may include electronic devices with sound playback functions, such as televisions, speakers, and mobile phones. Additionally, the target sound source 160 may also include a human throat. The pickup component 20 picks up ambient sound and converts it into a first audio signal y. The ambient sound includes the first sound from the sounding component 10 and the second sound from the target sound source 160. Therefore, the first audio signal y simultaneously includes a signal component x corresponding to the first sound and a signal component v corresponding to the second sound. The pickup component 20 sends the first audio signal y to the signal processing circuit 150.

The signal processing circuit 150 may be a circuit with certain signal processing capabilities. The input end of the signal processing circuit 150 is connected to the pickup component 20, and the output end is connected to the sounding component 10. The signal processing circuit 150 can obtain the first audio signal y from the pickup component 20 and use AFC technology to perform a preset signal processing procedure on the first audio signal y to obtain the second audio signal u (i.e., the new second audio signal u, or the second audio signal u for the next moment). Then, the signal processing circuit 150 sends the second audio signal u to the sounding component 10 to drive the sounding component 10 to produce sound. The specific signal processing procedure involved in AFC technology will be described in detail below with reference to FIG. 2.

Referring further to FIG. 2, in order to reduce or eliminate the feedback components in the acoustic system, the signal processing circuit 150 may include an acoustic feedback cancellation unit 151. The input to the acoustic feedback cancellation unit 151 includes the first audio signal y and the second audio signal u. For example, the acoustic feedback cancellation unit 151 may obtain the second audio signal u from other processing units within the signal processing circuit 150 and obtain the first audio signal y from the pickup component 20. The acoustic feedback cancellation unit 151 can use the second audio signal u to reduce the signal components in the first audio signal y that correspond to the first sound (i.e., the feedback component), thereby obtaining the signal e.

Specifically, the reduction principle is as follows: the acoustic feedback cancellation unit 151 internally solves and adaptively updates a time-varying transfer function F′ to fit the transfer function F corresponding to the feedback path (i.e., the transfer path of the feedback sound). For distinction, the transfer function F′ obtained through solving is referred to as the predicted transfer function F′, while the transfer function F corresponding to the feedback path is referred to as the real transfer function F. Continuing with reference to FIG. 2, the acoustic feedback cancellation unit 151 uses the predicted transfer function F′ to perform an adaptive filtering operation on the second audio signal u, obtaining the signal x′, that is, x′=u*F′. The signal x′ can be regarded as the predicted value of the feedback component in the first audio signal y (i.e., the signal component in the first audio signal y corresponding to the first sound). Then, the acoustic feedback cancellation unit 151 can subtract the signal x′ from the first audio signal y to obtain the signal e, that is, e=y−x′. The signal e obtained in this way does not contain or contains fewer feedback components.

It should be noted that the acoustic feedback cancellation unit 151 can employ various adaptive filtering algorithms to solve the predicted transfer function F′, such as Least Mean Square (LMS), Normalized Least Mean Square (NLMS), Recursive Least Squares (RLS), other adaptive filtering algorithms, and any derived algorithms of the aforementioned ones, either individually or in combination. This disclosure does not impose limitations on this aspect. Additionally, the adaptive filtering algorithms may perform adaptive filtering in the time domain, frequency domain, or other transformation domains.

Continuing with reference to FIG. 2, the signal processing circuit 150 may also include a gain amplification unit 152. The gain amplification unit 152 can perform a gain amplification operation on the signal e to obtain an amplified signal. Then, the signal processing circuit 150 sends the amplified signal as the second audio signal u (i.e., the new second audio signal u, or the second audio signal u for the next moment) to the sounding component 10 to drive the sounding component 10 to produce sound. According to the theory of adaptive filtering algorithms, the update of the predicted transfer function F′ can be achieved by minimizing the expected mean square function of the signal e, i.e.:

$${min}_{F ′} E [ {e}^{2} ] = {min}_{F ′} E [ {( y - u * {F}^{′} )}^{2} ] \qquad Formula ( 1 - 1 )$$

For example, taking the case where the acoustic feedback cancellation unit 151 uses the LMS algorithm, the update of the predicted transfer function F′ can be derived based on the gradient descent optimization method applied to the formula (1-1). The update formula for the predicted transfer function F′ is as follows:

$${F}^{′} ← {F}^{′} + μ * e * u \qquad Formula ( 2 - 1 )$$

Where μ is the iteration step size.

It should be understood that when the acoustic feedback cancellation unit 151 employs algorithms such as NLMS, RLS, etc., the update formula for the predicted transfer function F′ can be derived in a similar manner. This disclosure does not provide an example for each of these algorithms.

In summary, the acoustic system shown in FIG. 2 performs the AFC algorithm based on the first audio signal y and the second audio signal u, which can reduce or eliminate the feedback component in the first audio signal y, thereby preventing issues such as feedback-induced whistling and helping to improve the maximum forward gain that the acoustic system can achieve.

According to signal processing theory, the closed-loop gain A of the acoustic system shown in FIG. 2 can be expressed as follows:

$$A = \frac{u}{v} = \frac{G}{1 - G ( F - {F}^{′} )} \qquad Formula ( 3 - 1 )$$

According to the Nyquist stability criterion, the requirement for the acoustic system to cancel the feedback component is that the solved predicted transfer function F′ exactly equals the real transfer function F, i.e., F′=F. When this condition is met, the acoustic system will always be stable, no whistling will occur, and the system will achieve infinite gain. That is, when the forward gain G→∞, A=G→∞.

However, in practical acoustic systems, since the real transfer function F may be time-varying, and the iterative solving process may oscillate, the iterative process for F′ is unlikely to meet the ideal condition F′=F. In other words, there will be some deviation between the predicted transfer function F′ obtained in practice and the real transfer function F. In this case, to maintain the stability of the acoustic system, the forward gain G provided by the gain amplification unit 152 cannot be infinite. The maximum forward gain that the acoustic system can achieve is:

$${G}_{max} = \frac{1}{\vert F - {F}^{′} \vert} \qquad Formula ( 4 )$$

From equation (4), it can be seen that the deviation between the predicted transfer function F′ and the actual transfer function F can be used to measure the convergence performance of the adaptive filtering algorithm, and further measure the acoustic system's ability to cancel the feedback component. Specifically, if the deviation between the predicted transfer function F′ and the actual transfer function F is smaller, it indicates that the convergence performance of the adaptive filtering algorithm is better, and thus the acoustic system's ability to cancel the feedback component is better. If the deviation between the predicted transfer function F′ and the actual transfer function F is larger, it indicates that the convergence performance of the adaptive filtering algorithm is worse, and thus the acoustic system's ability to cancel the feedback component is worse.

In some exemplary embodiments, we can also use the misalignment quantity (MIS) to measure the convergence performance of the adaptive filtering algorithm. The misalignment quantity MIS can be expressed by the following formula:

$$MIS = 20 {log}_{10} \frac{\vert {F}^{′} - F \vert}{\vert F \vert} \qquad Formula ( 5 )$$

The misalignment (MIS) is measured in decibels (dB). When the predicted transfer function F′ is initialized to zero, the misalignment MIS is 0 dB. As the misalignment MIS decreases and approaches negative infinity, the deviation between the predicted transfer function F′ and the actual transfer function F becomes smaller, indicating better convergence performance of the adaptive filtering algorithm, and thus better feedback component cancellation by the acoustic system. Conversely, as the misalignment MIS increases and approaches positive infinity, the deviation between the predicted transfer function F′ and the actual transfer function F becomes larger, indicating poorer convergence performance of the adaptive filtering algorithm, and consequently worse feedback component cancellation by the acoustic system.

It should be noted that the convergence performance of the adaptive filtering algorithm in this disclosure includes, but is not limited to, factors such as convergence speed and convergence error. Specifically, the convergence speed refers to the rate at which the predicted transfer function F′ fits the actual transfer function F, while the convergence error refers to the deviation between the predicted transfer function F′ and the actual transfer function F when the convergence condition is met.

In practical applications, the design architecture of some acoustic systems restricts access permissions or communication capabilities between different units. For example, the acoustic feedback cancellation unit 151 cannot obtain the second audio signal u from other units within the signal processing circuit 150. Therefore, such acoustic systems cannot adopt AFC technology to reduce or eliminate feedback components.

Additionally, in the feedback component elimination scheme shown in FIG. 2, the reason why a time-varying predicted transfer function F′ can be solved using an adaptive filtering algorithm to fit the real transfer function F is based on the following ideal assumption: all feedback paths in the acoustic system exhibit purely linear transmission, or in other words, the response of the feedback paths is entirely linear. However, actual acoustic systems often fail to meet this ideal assumption. In real acoustic systems, nonlinear response components are typically present in the first peripheral circuit 130. For example, digital-to-analog conversion devices, filtering devices, modulation devices, etc., in the first peripheral circuit 130 generally exhibit nonlinear responses.

Based on the principle of the adaptive filtering algorithm, since the acoustic feedback cancellation unit 151 obtains the second audio signal u from other units within the signal processing circuit 150 (i.e., it obtains the second audio signal u at a position before the output end of the signal processing circuit 150), the actual feedback path of the feedback sound includes the transmission path from the extraction point of the second audio signal u by the acoustic feedback cancellation unit 151 (which can be approximately regarded as the output end of the signal processing circuit 150) to the extraction point of the first audio signal y by the acoustic feedback cancellation unit 151 (which can be approximately regarded as the input end of the signal processing circuit 150). In other words, the transmission effect of the above feedback path includes not only the transmission effect of the spatial path between the sounding component 10 and the pickup component 20 but also the transmission effect of the sounding component 10 itself (i.e., the transmission effect of the first peripheral circuit 130 and the transmission effect of the speaker 110), as well as the transmission effect of the pickup component 20 itself (i.e., the transmission effect of the sound sensor 120 and the transmission effect of the third peripheral circuit 140). Therefore, when the feedback component cancellation scheme shown in FIG. 2 is applied to an actual acoustic system, the predicted transfer function F′ essentially simulates the overall transmission effect of the feedback path, that is, it simulates the overall transmission effect of the first peripheral circuit 130, the speaker 110, the spatial path between the speaker 110 and the sound sensor 120, the sound sensor 120, and the third peripheral circuit 140.

Since there are nonlinear response components in the first peripheral circuit 130, these nonlinear response components are inevitably introduced into the iterative solution of the predicted transfer function F′, which leads to lower convergence performance of the adaptive filtering algorithm. For example, this may result in the predicted transfer function F′ failing to converge, converging slowly, or having a large convergence error. Additionally, the first peripheral circuit 130 may also have caching (cached) or delay (delay) effects. These caching or delay effects will cause a certain time shift in the predicted transfer function F′ obtained through the solution process. Moreover, since the order of the adaptive filtering algorithm is typically limited, especially in acoustic systems with high real-time requirements and limited computational resources, where the order of the adaptive filtering algorithm is relatively low, the presence of significant caching or delay effects will further degrade the convergence performance of the adaptive filtering algorithm. A person skilled in the art will understand that when the convergence performance of the adaptive filtering algorithm is low, the misalignment metric (MIS) of the acoustic system worsens, and the effectiveness of feedback component cancellation decreases.

To solve at least one of the above technical problems, the acoustic system provided in this disclosure can obtain a second reference signal from the electrical domain and use this second reference signal to eliminate the feedback components in the first audio signal y.

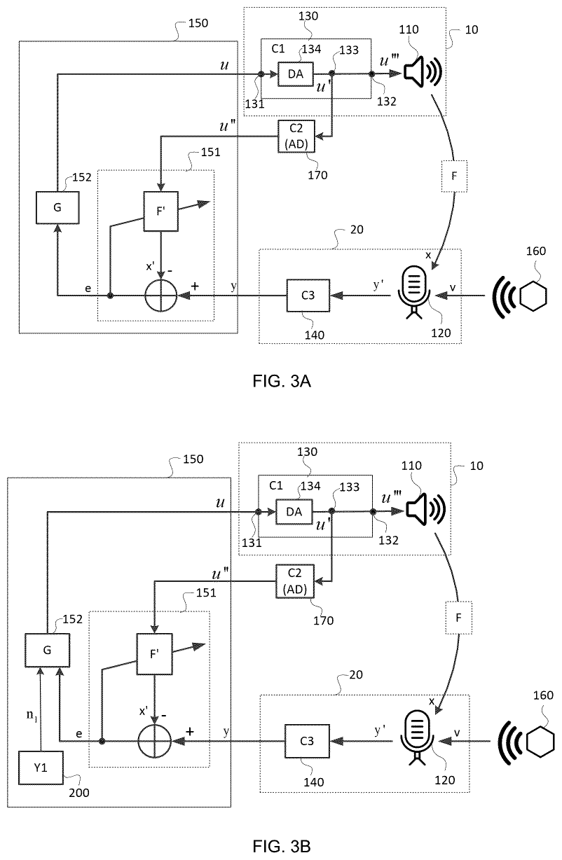

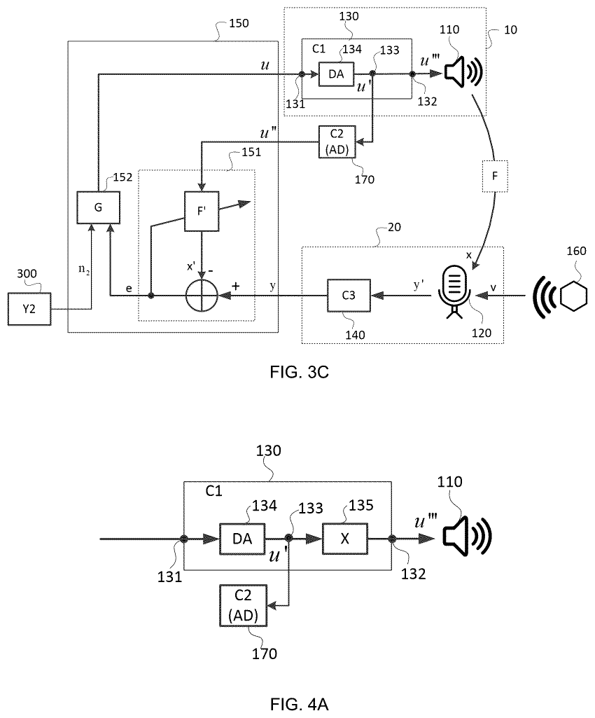

FIG. 3A is a schematic diagram of an acoustic system provided according to some exemplary embodiments of this disclosure. As shown in FIG. 3A, the acoustic system may include a sounding component 10, a pickup component 20, and a signal processing circuit 150. The sounding component 10 may include a speaker 110 and a first peripheral circuit 130, while the pickup component 20 may include a sound sensor 120 and a third peripheral circuit 140. The signal processing circuit 150 may include an acoustic feedback cancellation unit 151. When the acoustic system operates, the pickup component 20 captures ambient sound, converts the ambient sound into a first audio signal y, and transmits the first audio signal y to the signal processing circuit 150. After receiving the first audio signal y, the signal processing circuit 150 processes the first audio signal y using the acoustic feedback cancellation unit 151 to attenuate the feedback components in the first audio signal y, thereby obtaining a target signal e.

Continuing to refer to FIG. 3A, the speaker 110 and the signal processing circuit 150 are connected via the first peripheral circuit 130. The first peripheral circuit 130 may include an input port 131 and an output port 132. The input port 131 refers to the port where the first peripheral circuit 130 connects to the signal processing circuit 150, while the output port 132 refers to the port where the first peripheral circuit 130 connects to the speaker 110. When the first peripheral circuit 130 operates, it obtains the second audio signal u through the input port 131, converts the second audio signal u into a driving signal u′″, and transmits the driving signal u′″ to the speaker 110 through the output port 132 to drive the speaker 110 to produce sound.

In some exemplary embodiments, the second audio signal u obtained by the first peripheral circuit 130 through the input port 131 may come from the target signal e. The phrase “the second audio signal u comes from the target signal e” can include the following two situations: Situation 1: The second audio signal u is the same as the target signal e; Situation 2: The second audio signal u is obtained by performing a preset processing on the target signal e. The preset processing mentioned above can include one or more of the following: gain amplification, frequency division, filtering, or other possible processing methods. FIG. 3A illustrates the situation of Situation 2. For example, referring to FIG. 3A, the signal processing circuit 150 may further include a gain amplification unit 152. The gain amplification unit can perform a gain amplification operation on the target signal e to obtain the second audio signal u. In this case, the input port 131 of the first peripheral circuit 130 can be connected to the gain amplification unit 152. Thus, the second audio signal u obtained by the first peripheral circuit 130 through the input port 131 is the signal obtained by amplifying the target signal e, meaning that the second audio signal u comes from the target signal e.

In the acoustic system illustrated in FIG. 3A, all signal components of the second audio signal u come from the target signal e, forming a signal loop between the pickup component 20, the acoustic feedback cancellation unit 151, the gain amplification unit 152, the first peripheral circuit 130, and the speaker 110. However, in some cases, only a portion of the signal components in the second audio signal u may come from the target signal e.

Specifically, the second audio signal u may include a first signal component and a second signal component, where the first signal component comes from the target signal e, and the second signal component comes from a target audio component. The target audio component is a component that has an audio output function and is different from the pickup component 20. The target audio component can either be integrated into the signal processing circuit 150 or be an external component to the signal processing circuit 150 (for example, the target audio component can be integrated into a circuit within the acoustic system other than the signal processing circuit 150, or it can be another external acoustic device).

For example, in some exemplary embodiments, the target audio component 200 may be a Bluetooth component, which can be integrated within the signal processing circuit 150, or integrated within other circuit systems. The Bluetooth component can receive Bluetooth audio signals from external acoustic devices. In some exemplary embodiments, the target audio component 200 may also be a built-in codec component within the signal processing circuit 150, which can decode the built-in audio to generate a prompt sound. In some exemplary embodiments, the target audio component 200 may also be other external components/external devices that are wired connected to the acoustic system.

FIG. 3B shows a schematic diagram of the acoustic system provided according to some exemplary embodiments of this disclosure. As shown in FIG. 3B, the signal processing circuit 150 may also include a first audio component 200 (marked as Y1 in the figure). The first audio component 200 can be connected to the gain amplification unit 152. The first audio component 200 can provide signal n₁ to the gain amplification unit 152. In this way, the gain amplification unit 152 can obtain the target signal e from the sound feedback cancellation unit 151 on the one hand, and obtain the signal n₁ from the first audio component 200 on the other hand. The gain amplification unit 152 can perform gain amplification processing on the target signal e and the signal n₁, as well as appropriate mixing and superimposing calculations to obtain a second audio signal u. Therefore, in this case, part of the signal components in the second audio signal u comes from the target signal e, and another part of the signal components comes from the first audio component 200.

FIG. 3C shows a schematic diagram of the acoustic system provided according to the embodiments of this disclosure. As shown in FIG. 3C, the acoustic system may also include a second audio component 300 (marked as Y2 in the figure), with the second audio component 300 located outside the signal processing circuit 150. The second audio component 300 can be connected to the gain amplification unit 152. The second audio component 300 can provide signal n₂ to the gain amplification unit 152. In this way, the gain amplification unit 152 can obtain the target signal e from the sound feedback cancellation unit 151 on the one hand, and obtain signal n₂ from the second audio component 300 on the other hand. The gain amplification unit 152 can perform gain amplification processing on the target signal e and signal n₂, as well as appropriate mixing and superimposing calculations to obtain the second audio signal u. Therefore, in this case, part of the signal components in the second audio signal u comes from the target signal e, and another part of the signal components comes from the second audio component 300.

A person skilled in the art would understand that, in practical applications, the above-mentioned FIGS. 3B and 3C can be combined with each other. For example, the acoustic system may include both the first audio component 200 and the second audio component 300, with both being connected to the gain amplification unit 152. The first audio component 200 provides signal n₁ to the gain amplification unit 152, the second audio component 300 provides signal n₂ to the gain amplification unit 152, and the sound feedback cancellation unit 151 provides the target signal e to the gain amplification unit 152. In this case, the gain amplification unit 152 performs gain amplification processing on the target signal e, signal n₁, and signal n₂, as well as appropriate mixing and superimposing calculations to obtain the second audio signal u. In this case, part of the signal components in the second audio signal u comes from the target signal e, part comes from the first audio component 200, and another part comes from the second audio component 300.

Continuing with reference to FIG. 3A to 3C, a reference signal pickup point 133 (reference signal pickup point) may exist in the first peripheral circuit 130. The signal flowing through the reference signal pickup point 133 in the first peripheral circuit 130 can be referred to as the first reference signal u′.

In some exemplary embodiments, the first reference signal u′ may be a time-continuous signal. In some exemplary embodiments, the first reference signal u′ may be a time-discrete signal. In some exemplary embodiments, the first reference signal u′ may be a signal modulated by one or more modulation techniques. In some exemplary embodiments, the first reference signal u′ may be an unmodulated signal. In some exemplary embodiments, the first reference signal u′ may be a monaural signal. In some exemplary embodiments, the first reference signal u′ may be a stereo signal. In some exemplary embodiments, the first reference signal u′ may be a signal formed by overlapping multichannel signals. In some exemplary embodiments, the first reference signal u′ may be a signal capable of directly driving the speaker 110 to produce sound. In some exemplary embodiments, the first reference signal u′ may be a signal that cannot directly drive the speaker 110 to produce sound, but can do so after modulation.

For example, the signal type (signal standard/format) of the first reference signal u′ includes at least one of the following (1) to (6).

(1) Analog signal. An analog signal refers to a signal represented by a continuously varying physical quantity, where the amplitude, frequency, or phase of the signal changes continuously over time, or, within a continuous time interval, the characteristic quantity representing the information can present any value at any instant.

(2) Pulse Width Modulation (PWM) signal. A PWM signal refers to a signal modulated using pulse width modulation technology. Pulse width modulation modulates the width of a series of pulses to equivalently generate the required waveform and perform digital encoding of the analog signal level.

(3) Pulse Density Modulation (PDM) signal. A PDM signal refers to a signal modulated using pulse density modulation technology. Pulse density modulation is a modulation method that uses binary numbers 0 and 1 to represent an analog signal. In a PDM signal, the amplitude of the analog signal is represented by the density of pulses corresponding to a specific region. For example, in some pulse density modulation methods, the data stream of the PDM signal contains only 1s and 0s. The greater the density of 1s, the larger the amplitude of the analog signal in that region. Conversely, the greater the density of 0s, the smaller the amplitude of the analog signal in that region.

(4) Pulse Code Modulation (PCM) signal. PCM refers to a signal modulated using pulse code modulation technology. The process of pulse code modulation is as follows: first, the analog signal is sampled at regular intervals to discretize it, and then the discretized sampled values are quantized and encoded to obtain the PCM signal. PCM can be considered a monaural signal.

(5) Integrated circuit built-in audio I2S (Inter-IC Sound) signal. An I2S signal refers to a signal transmitted based on the I2S bus. The I2S signal can be considered as a signal formed by interleaving a stereo PCM signal.

(6) Time Division Multiplexing (TDM) signal. A TDM signal refers to a signal obtained by interleaving multiple signals using time division multiplexing technology. For example, a TDM signal can be a signal formed by interleaving multichannel PCM signals using time division multiplexing technology.

Among the above signal types, analog signals, PWM signals, and some PDM signals can directly drive the speaker 110, while PCM signals, I2S signals, TDM signals, and other PDM signals cannot directly drive the speaker 110 and need to be demodulated and decoded before they can drive the speaker 110. Among the above signal types, except for the analog signal, the other types (PWM signal, PDM signal, PCM signal, I2S signal, TDM signal) can be considered as modulated signals.

A person skilled in the art will understand that the signal types listed above are merely some possible examples. With the evolution and development of technology, the signal type of the first reference signal u′ could also be any other possible type.

It should be noted that the reference signal pickup point 133 can be located at any position within the first peripheral circuit 130, and the embodiments of this disclosure do not limit this. Below, several possible implementation methods are provided as examples to illustrate the location of the reference signal pickup point 133.

In some exemplary embodiments, the reference signal pickup point 133 can be located at the input port 131, meaning that there are no circuit components between the input port 131 and the reference signal pickup point 133. In this case, the first reference signal u′ at the reference signal pickup point 133 is the same as the second audio signal u.

In some exemplary embodiments, the reference signal pickup point 133 can be located at the output port 132, meaning that there are no circuit components between the reference signal pickup point 133 and the output port 132. In this case, the first reference signal u′ at the reference signal pickup point 133 is the same as the driving signal u′″.

In some exemplary embodiments, the reference signal pickup point 133 can be located at a position between the input port 131 and the output port 132. That is, there is at least one circuit component between the input port 131 and the reference signal pickup point 133, and there is also at least one circuit component between the reference signal pickup point 133 and the output port 132. In other words, the reference signal pickup point 133 can divide the first peripheral circuit 130 into a first circuit portion and a second circuit portion. The first circuit portion refers to the circuit portion located between the input port 131 and the reference signal pickup point 133, and the second circuit portion refers to the circuit portion located between the reference signal pickup point 133 and the output port 132. Both the first circuit portion and the second circuit portion are non-empty. In this case, the first reference signal u′ at the reference signal pickup point 133 is the signal after the first circuit portion has pre-processed the second audio signal u. The first reference signal u′ is different from the second audio signal u, and the first reference signal u′ is also different from the driving signal u′″.

For example, continuing with reference to FIG. 3A to 3C, the first peripheral circuit 130 may include a first processing component 134 (marked as DA in the figure). The first processing component 134 is connected to the signal processing circuit 150 through the input port 131. When operating, the first processing component 134 obtains the second audio signal u from the signal processing circuit 150 and performs at least one of a digital-to-analog conversion operation, a modulation operation, or a filtering operation on the second audio signal u.

The first processing component 134 may include one or more circuit components, and the embodiments of this disclosure do not limit this. Below are some examples. For instance, the first processing component 134 may include one circuit component that performs at least one of the aforementioned digital-to-analog conversion, modulation, or filtering operations. Alternatively, the first processing component 134 may include three circuit components, where the first circuit component performs the digital-to-analog conversion operation, the second circuit component performs the modulation operation, and the third circuit component performs the filtering operation. Another example is that the first processing component 134 may include two circuit components, where the first circuit component performs both the digital-to-analog conversion and modulation operations, and the second circuit component performs the filtering operation. It should be noted that these examples are for illustrative purposes and do not limit the embodiments of this disclosure.

Continuing with reference to FIG. 3A to 3C, in the case where the first peripheral circuit 130 includes the first processing component 134, the reference signal pickup point 133 can be located between the first processing component 134 and the output port 132. That is, the reference signal pickup point 133 can be located at any position along the signal path after the first processing component 134.

In some cases, the first peripheral circuit 130 may include only the first processing component 134 and no other components. In this case, the reference signal pickup point 133 can be set after the first processing component 134, which can also be considered as the reference signal pickup point 133 being located at the output port 132.

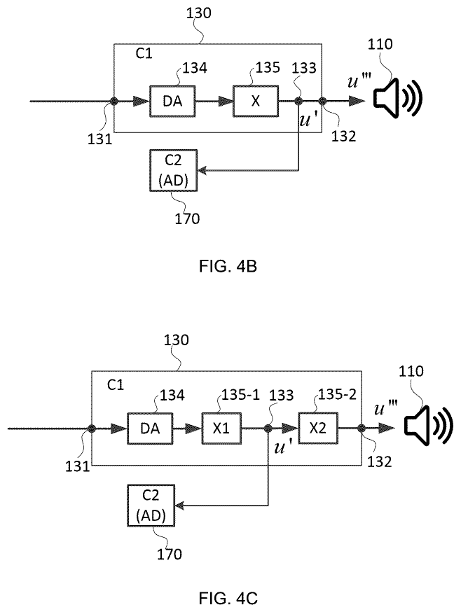

In other cases, the first peripheral circuit 130 may include, in addition to the first processing component 134, a second processing component 135. The second processing component 135 is connected between the first processing component 134 and the output port 132. The second processing component 135 can be configured to perform at least one of a filtering operation, a gain operation, or other possible operations. The second processing component 135 may include one circuit component or multiple circuit components. Below, with reference to FIG. 4A to 4C, the location of the reference signal pickup point 133 in this case will be illustrated.

FIG. 4A to 4C show several schematic diagrams of the possible locations of the reference signal pickup point 133 in the acoustic system. In some exemplary embodiments, referring to FIG. 4A, the reference signal pickup point 133 can be located between the first processing component 134 and the second processing component 135. In some exemplary embodiments, referring to FIG. 4B, the reference signal pickup point 133 can be located between the second processing component 135 and the output port 132. In some exemplary embodiments, when the second processing component 135 includes multiple circuit components, the reference signal pickup point 133 can be located between any two of the multiple circuit components. FIG. 4C illustrates this with the second processing component 135 comprising two circuit components 135-1 and 135-2. Referring to FIG. 4C, the reference signal pickup point 133 can be located between circuit component 135-1 and circuit component 135-2. It should be noted that FIGS. 4A to 4C are merely some possible examples, and in addition to these, the reference signal pickup point 133 can be set in other ways. A person skilled in the art will understand that the positioning schemes of the reference signal pickup point shown in FIGS. 4A to 4C can be applied to the acoustic system shown in FIG. 3A, the acoustic system shown in FIG. 3B, or the acoustic system shown in FIG. 3C.

The acoustic system shown in FIG. 3A to 3C is described with the first peripheral circuit 130 including only one input port 131 as an example. However, in some cases, the first peripheral circuit 130 can include multiple input ports, where each input port is used to receive a signal source for driving the speaker 110.

For convenience of description, suppose that the input port 131 of the first peripheral circuit 130 includes K branch ports, namely 131-1, 131-2 . . . , 131-K, where K is an integer greater than 1. In this case, the first peripheral circuit 130 can obtain branch audio signals u₁ through branch port 131-1, branch audio signal u₂ through branch port 131-2, and so on, obtaining branch audio signal uk through branch port 131-K. In this case, the first peripheral circuit 130 obtains K branch audio signals through K branch ports, converts these K branch audio signals into the driving signal u′″, and sends the driving signal u′″ to the speaker 110 through the output port 132.

In some exemplary embodiments, the branch audio signals obtained by the first peripheral circuit 130 through K branch ports may all come from the target signal e.

“Branch audio signals come from the target signal e” can include the following two cases: Case 1: The branch audio signal is the same as the target signal e; Case 2: The branch audio signal is a signal obtained by performing preset processing on the target signal e. The preset processing can include one or more of the following: gain amplification, frequency division, filtering, or other possible processing methods.

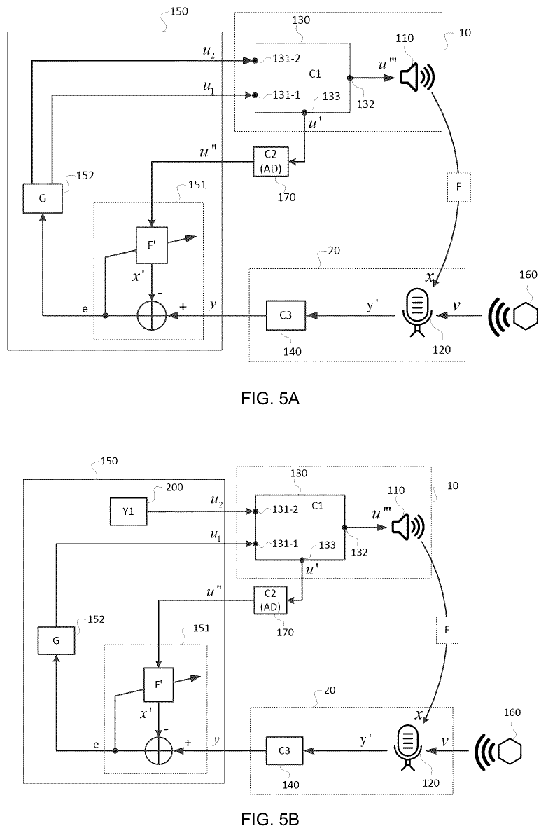

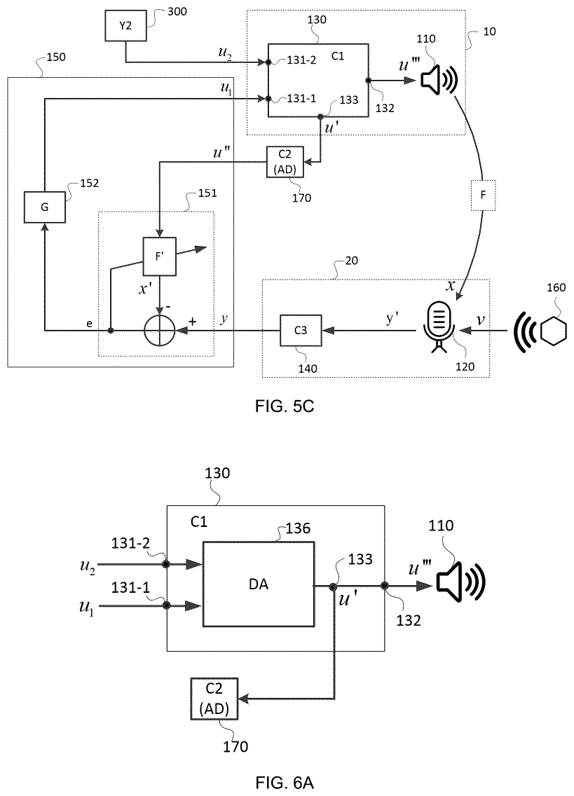

FIG. 5A shows a connection scenario of the K branch ports in the first peripheral circuit 130 of an acoustic system. FIG. 5A depicts the aforementioned Case 2, using K=2 as an example. As shown in FIG. 5A, the signal processing circuit 150 includes an acoustic feedback cancellation unit 151 and a gain amplification unit 152. The branch ports 131-1 and 131-2 in the first peripheral circuit 130 are both connected to the gain amplification unit 152. The acoustic feedback cancellation unit 151 processes the first audio signal y to reduce the feedback components within it, thereby obtaining the target signal e. The gain amplification unit 152 performs gain amplification on the target signal e to generate branch audio signals u₁ and u₂. In this case, the first peripheral circuit 130 acquires branch audio signal u₁ through branch port 131-1 and branch audio signal u₂ through branch port 131-2. Since both branch audio signals u₁ and u₂ are obtained by processing the target signal e, they both originate from the target signal e.

In some exemplary embodiments, the K branch ports may include a first subset of branch ports and a second subset of branch ports. The first peripheral circuit 130 acquires branch audio signals from the target signal e through the first subset of branch ports, while it acquires branch audio signals from a target audio component through the second subset of branch ports.

The target audio component is a component different from the pickup component 20 and has an audio output function. The target audio component may be integrated into the signal processing circuit 150 or may be an external component relative to the signal processing circuit 150. For example, the target audio component may be integrated into other circuits within the acoustic system besides the signal processing circuit 150 or may be an external acoustic device.

For example, in some exemplary embodiments, the target audio component may be a Bluetooth component, which can be integrated within the signal processing circuit 150 or in other circuit systems. The Bluetooth component can receive Bluetooth audio signals from an external acoustic device. In some exemplary embodiments, the target audio component may be a codec component built into the signal processing circuit 150, which can decode built-in audio to generate prompt tones. In some exemplary embodiments, the target audio component may also be other external components/external devices that are wired to the acoustic system.

FIG. 5B illustrates a connection scenario of the K branch ports of the first peripheral circuit 130 in the acoustic system. FIG. 5B takes K=2 as an example. As shown in FIG. 5B, the signal processing circuit 150 includes an acoustic feedback cancellation unit 151, a gain amplification unit 152, and a first audio component 200 (labeled as Y1 in the figure). Among them, the branch port 131-1 in the first peripheral circuit 130 is connected to the gain amplification unit 152, and the branch port 131-2 is connected to the first audio component 200. The acoustic feedback cancellation unit 151 processes the first audio signal y to reduce the feedback component in the first audio signal y, thereby obtaining the target signal e. The gain amplification unit 152 performs gain amplification processing on the target signal e to obtain the branch audio signal u₁ and outputs the branch audio signal u₁ to the branch port 131-1. The first audio component 200 outputs the branch audio signal u₂ to the branch port 131-2. In this way, the first peripheral circuit 130 can obtain the branch audio signal u₁ through the branch port 131-1 and obtain the branch audio signal u₂ through the branch port 131-2. In this case, the branch audio signal u₁ is the signal obtained by processing the target signal e, that is, the branch audio signal u₁ originates from the target signal e, while the branch audio signal u₂ originates from the first audio component 200.

FIG. 5C shows a connection scenario of the K branch ports of the first peripheral circuit 130 in the acoustic system. FIG. 5C takes K=2 as an example. As shown in FIG. 50, the signal processing circuit 150 includes an acoustic feedback cancellation unit 151 and a gain amplification unit 152. The acoustic system also includes a second audio component 300 (labeled as Y2 in the figure), which is located outside the signal processing circuit 150. In the first peripheral circuit 130, the branch port 131-1 is connected to the gain amplification unit 152, and the branch port 131-2 is connected to the second audio component 300. The acoustic feedback cancellation unit 151 processes the first audio signal y to reduce the feedback component in the first audio signal y, thereby obtaining the target signal e. The gain amplification unit 152 performs gain amplification processing on the target signal e to obtain the branch audio signal u₁ and outputs the branch audio signal u₁ to the branch port 131-1. The second audio component 300 outputs the branch audio signal u₂ to the branch port 131-2. In this way, the first peripheral circuit 130 can obtain the branch audio signal u₁ through the branch port 131-1 and obtain the branch audio signal u₂ through the branch port 131-2. In this case, the branch audio signal u₁ is the signal obtained by processing the target signal e, that is, the branch audio signal u₁ originates from the target signal e, while the branch audio signal u₂ originates from the second audio component 300.

A person skilled in the art can understand that, in practical applications, FIG. 5B and FIG. 5C can be combined. For example, the acoustic system may include both the first audio component 200 and the second audio component 300, where the first audio component 200 is located inside the signal processing circuit 150, and the second audio component 300 is located outside the signal processing circuit 150. Both components are connected to the branch ports in the first peripheral circuit 130.

In this case, among the multiple branch audio signals received by the first peripheral circuit 130, some branch audio signals originate from the target signal e, some branch audio signals originate from the first audio component 200, and other branch audio signals originate from the second audio component 300. When the first peripheral circuit 130 includes multiple branch ports (as shown in FIG. 5A to FIG. 5C), the position of the reference signal pickup point 133 is illustrated with several examples below. The following examples use a scenario where the first peripheral circuit 130 includes two branch ports as a demonstration.

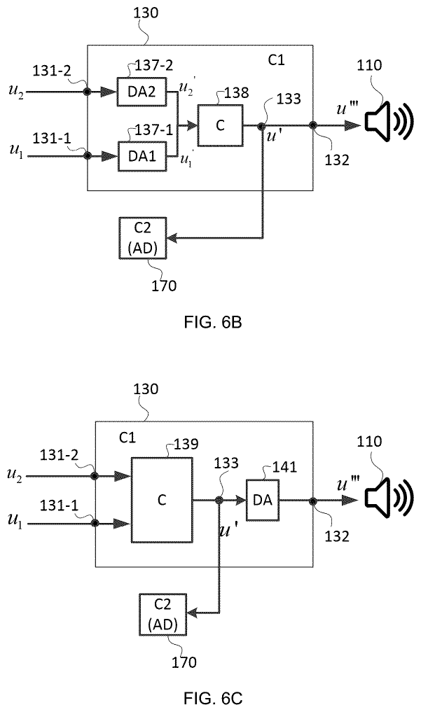

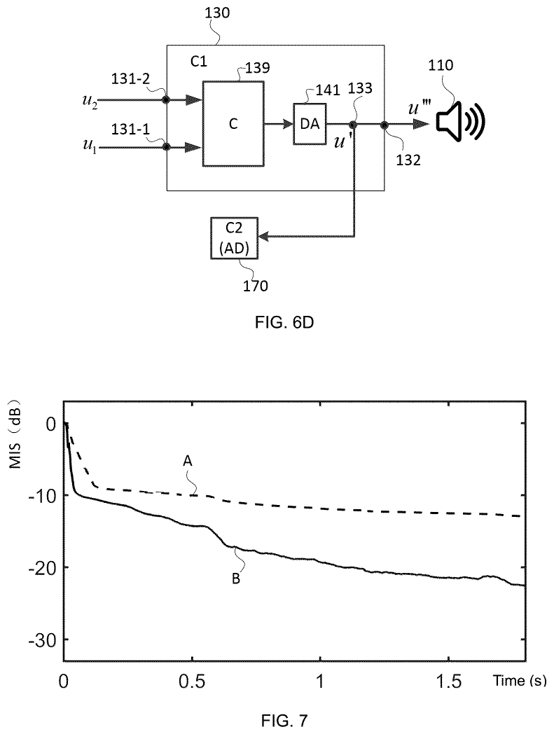

FIG. 6A illustrates a schematic diagram of one possible position of the reference signal pickup point 133. As shown in FIG. 6A, the first peripheral circuit 130 may include a third processing component 136 (labeled as DA in the figure). The third processing component 136 obtains the branch audio signal u₁ from branch port 131-1 and the branch audio signal u₂ from branch port 131-2. It performs at least one of digital-to-analog conversion, modulation, filtering, or mixing operations on these two branch audio signals. It should be noted that the third processing component 136 may include one or more circuit elements, and the embodiments of this disclosure are not limited in this regard. In this case, the reference signal pickup point 133 may be located between the third processing component 136 and the output port 132.

In some cases, the first peripheral circuit 130 includes only the third processing component 136 and no other components. In these cases, the reference signal pickup point 133 can be positioned after the third processing component 136, which can also be regarded as the reference signal pickup point 133 being located at the output port 132. In other cases, in addition to the third processing component 136, the first peripheral circuit 130 may also include a second processing component 135. The second processing component 135 is connected between the third processing component 136 and the output port 132. The second processing component 135 can be configured to perform at least one of filtering operations, gain operations, or other possible operations. The second processing component 135 may include one circuit element or multiple circuit elements. In this case, the position of the reference signal pickup point 133 may be similar to those shown in FIG. 4A to FIG. 4C, and further details are not repeated herein.

FIG. 6B is a schematic diagram of one possible position of the reference signal pickup point 133. As shown in FIG. 6B, the first peripheral circuit 130 may include two branch processing components 137-1 and 137-2 (labeled as DA1 and DA2 in the figure, where DA1 and DA2 can perform the same or different operations to process the same or different signals) and a first mixing component 138 (labeled as C in the figure). The branch processing component 137-1 is connected to branch port 131-1 and, during operation, obtains the branch audio signal u₁ from branch port 131-1. It performs at least one of digital-to-analog conversion, modulation, or filtering operations on the branch audio signal u₁ to obtain an intermediate audio signal u₁′. Similarly, the branch processing component 137-2 is connected to branch port 131-2 and, during operation, obtains the branch audio signal u₂ from branch port 131-2. It performs at least one of digital-to-analog conversion, modulation, or filtering operations on the branch audio signal u₂ to obtain an intermediate audio signal u₂′. The first mixing component 138 is connected to both branch processing components 137-1 and 137-2 and, during operation, performs a mixing operation on the intermediate audio signals u′ and u₂′. In this case, the reference signal pickup point 133 may be located between the first mixing component 138 and the output port 132.

In some cases, the first peripheral circuit 130 includes only the branch processing components 137-1, 137-2, and the first mixing component 138, with no other components. In these cases, the reference signal pickup point 133 can be positioned after the first mixing component 138, which can also be regarded as the reference signal pickup point 133 being located at the output port 132. In other cases, in addition to the branch processing components 137-1, 137-2, and the first mixing component 138, the first peripheral circuit 130 may also include a second processing component 135. For example, the second processing component 135 can be connected between the first mixing component 138 and the output port 132. The second processing component 135 can be configured to perform at least one of filtering operations, gain operations, or other possible operations. The second processing component 135 may include one or more circuit elements. In this case, the position of the reference signal pickup point 133 may be similar to those shown in FIG. 4A to FIG. 4C, and further details are not repeated herein.

FIG. 6C and FIG. 6D illustrate several possible positions of the reference signal pickup point 133. As shown in FIG. 6C and FIG. 6D, the first peripheral circuit 130 may include a second mixing component 139 (labeled as C in the figure) and a fourth processing component 141 (labeled as DA in the figure). The second mixing component 139 is connected to branch ports 131-1 and 131-2, respectively. The second mixing component 139 obtains the branch audio signal u₁ from branch port 131-1 and the branch audio signal u₂ from branch port 131-2. It performs a mixing operation on the branch audio signals u₁ and u₂ to obtain a mixed audio signal. The fourth processing component 141 is connected to the second mixing component 139 and performs at least one of digital-to-analog conversion, modulation, or filtering operations on the mixed audio signal. In this case, the reference signal pickup point 133 can be located between the second mixing component 139 and the output port 132. For example, referring to FIG. 6C, the reference signal pickup point 133 can be located between the second mixing component 139 and the fourth processing component 141. For example, referring to FIG. 6D, the reference signal pickup point 133 can be located between the fourth processing component 141 and the output port 132.

In some cases, the first peripheral circuit 130 includes only the second mixing component 139 and the fourth processing component 141, with no other components. In these cases, the reference signal pickup point 133 can be positioned after the fourth processing component 141, which can also be regarded as the reference signal pickup point 133 being located at the output port 132. In other cases, in addition to the second mixing component 139 and the fourth processing component 141, the first peripheral circuit 130 may also include a second processing component 135. The second processing component 135 is connected between the fourth processing component 141 and the output port 132. The second processing component 135 can be configured to perform at least one of filtering operations, gain operations, or other possible operations. The second processing component 135 may include one or more circuit elements. In this case, the position of the reference signal pickup point 133 can be located at any position after the fourth processing component 141. The specific implementation is similar to those shown in FIG. 4A to FIG. 4C, and further details are not repeated herein.

A person skilled in the art can understand that FIG. 6A to FIG. 6D show only partial circuits in the acoustic system. These partial circuits can be applied to the acoustic system shown in FIG. 5A, as well as to the acoustic system shown in FIG. 5B. According to the embodiments of this disclosure, the acoustic system may also include a second peripheral circuit 170 (labeled as C2 in the figure). As shown in FIG. 3A to FIG. 3C and FIG. 5A to FIG. 5C, the second peripheral circuit 170 is connected between the reference signal pickup point 133 and the signal processing circuit 150. Specifically, the input of the second peripheral circuit 170 is connected to the reference signal pickup point 133, and the output is connected to the signal processing circuit 150. During operation, the second peripheral circuit 170 obtains the first reference signal u′ from the reference signal pickup point 133, converts the first reference signal u′ into a second reference signal u″, and outputs the second reference signal u″ to the signal processing circuit 150.

The second reference signal u″ is a digital signal, meaning it is a signal that can be directly used for mathematical operations by the signal processing circuit 150. It is typically stored in the memory or cache of the signal processing circuit 150, or in the cache of an edge device. In the embodiments of this disclosure, the second reference signal u″ is used for the signal at the speaker 110. For example, the second reference signal u″ can be made equal to or approximately equal to the driving signal u′″ of the speaker 110.

Since the first reference signal u′ is obtained from the reference signal pickup point 133 in the first peripheral circuit 130, the first reference signal u′ can be regarded as an intermediate signal obtained after the first circuit portion in the first peripheral circuit 130 performs preset operations on the second audio signal u. Therefore, after obtaining the first reference signal u′, the second peripheral circuit 170 can perform certain operations (such as the inverse or opposite operations corresponding to the preset operations mentioned above) on the first reference signal u′ to ensure that the resulting second reference signal u″ can simulate the signal at the speaker 110 as closely as possible.

In some exemplary embodiments, the second peripheral circuit 170 can perform at least one of the following operations on the first reference signal u′: analog-to-digital conversion, demodulation, filtering, or gain adjustment, in order to obtain the second reference signal u″. A person skilled in the art will understand that the specific operations performed by the second peripheral circuit 170 on the first reference signal u′ depend on the operations performed by the first circuit portion in the first peripheral circuit 130 on the second audio signal u, and/or the signal type of the first reference signal u′.

For example, if the first reference signal u′ is a continuous analog signal, in some possible implementations, the second peripheral circuit 170 can perform an analog-to-digital conversion on the first reference signal u′ to obtain the second reference signal u″.

For example, if the first reference signal u′ is a PWM signal, in some possible implementations, the second peripheral circuit 170 can first perform a filtering operation on the first reference signal u′ to remove the high-frequency carrier components. Then, it can perform an analog-to-digital conversion on the filtered signal to obtain the second reference signal u″.

For example, if the first reference signal u′ is a PDM signal, in some possible implementations, the second peripheral circuit 170 can first perform a filtering operation on the first reference signal u′ to remove the high-frequency carrier components. Then, it can perform an analog-to-digital conversion on the filtered signal to obtain the second reference signal u″. Additionally, in some cases, the signal processing circuit 150 can directly receive and decode the PDM signal via the GPIO digital port. In this case, the second peripheral circuit 170 can perform either the filtering operation or the analog-to-digital conversion operation on the first reference signal u′, or neither of these two operations may need to be performed.

For example, if the first reference signal u′ is a PCM signal, I2S signal, or TDM signal, in some possible implementations, the second peripheral circuit 170 can perform a demodulation operation.

It should be noted that the above examples are provided for ease of understanding and should not be construed as limiting the embodiments of this disclosure. A person skilled in the art will understand that the second peripheral circuit 170 can be implemented in various other ways, and this disclosure does not attempt to enumerate all possible implementations.

The second peripheral circuit 170 may include one or more circuit components, and the embodiments of this disclosure are not limited in this regard. Below are some examples: For instance, the second peripheral circuit 170 may include one circuit component that can perform at least one of the following operations: analog-to-digital conversion, demodulation, filtering, or gain adjustment. Alternatively, the second peripheral circuit 170 may include two circuit components, where one circuit component performs analog-to-digital conversion, and the other performs demodulation. Furthermore, the second peripheral circuit 170 may include three circuit components, where the first circuit component performs analog-to-digital conversion and demodulation, the second circuit component performs filtering, and the third circuit component performs gain adjustment. It should be noted that the above examples are provided for ease of understanding and do not limit the embodiments of this disclosure.

Next, with reference to FIG. 3A, the process of feedback component cancellation in the acoustic system provided by this disclosure will be explained. It should be noted that for the acoustic systems shown in FIGS. 3B, 3C, 5A, 5B, and 5C, the feedback cancellation process is similar, and this disclosure will not reiterate it in detail.

Referring to FIG. 3A, the working process of the acoustic system is as follows: The first peripheral circuit 130 obtains the second audio signal u from the signal processing circuit 150 through input port 131, converts the second audio signal u into the driving signal u′″, and sends the driving signal u′″ to the speaker 110 through output port 132. The speaker 110 converts the driving signal u′″ into the first sound. The target sound source 160 emits the second sound. The sound sensor 120 collects ambient sound and converts the ambient sound into the pickup signal y′, while the third peripheral circuit 140 converts the pickup signal y′ into the first audio signal y and outputs the first audio signal y to the signal processing circuit 150. The second peripheral circuit 170 obtains the first reference signal u′ from the reference signal pickup point 133, converts the first reference signal u′ into the second reference signal u″, and outputs the second reference signal u″ to the signal processing circuit 150.

After the signal processing circuit 150 obtains the first audio signal y from the third peripheral circuit 140 and the second reference signal u″ from the second peripheral circuit 170, the second reference signal u″ is applied in the AFC (Acoustic Feedback Cancellation) technology. That is, the signal processing circuit 150 can reduce the signal components corresponding to the first sound in the first audio signal y based on the second reference signal u″ to obtain the target signal e.

Specifically, continuing with reference to FIG. 3A, the signal processing circuit 150 may include an acoustic feedback cancellation unit 151. The input to the acoustic feedback cancellation unit 151 includes the first audio signal y and the second reference signal u″. Inside the acoustic feedback cancellation unit 151, a time-varying transfer function F′ can be solved and adaptively updated to fit the true transfer function F corresponding to the feedback path (i.e., the transfer path of the feedback sound). The acoustic feedback cancellation unit 151 uses the predicted transfer function F′ to perform adaptive filtering on the second reference signal u″ to obtain the signal x′, i.e., x′=u″*F′. The signal x′ can be viewed as the predicted value of the feedback component (i.e., the signal component in the first audio signal y corresponding to the first sound). Further, the acoustic feedback cancellation unit 151 can subtract the signal x′ from the first audio signal y to obtain the target signal e, i.e., e=y−x′. The target signal e thus obtained contains little or no feedback component.

After obtaining the target signal e, the signal processing circuit 150 can also update the filtering parameters of the adaptive filtering operation based on the second reference signal u″ and at least one of the target signal e, that is, update the prediction transfer function F′. Specifically, according to the theory of the adaptive filtering algorithm, the update method of the prediction transfer function F′ can be achieved by minimizing the expected value of the mean square function of the target signal e, that is:

$${min}_{F ′} E [ {e}^{2} ] = {min}_{F ′} E [ {( y - {u}^{″} * {F}^{′} )}^{2} ] \qquad Formula ( 1 - 2 )$$

Still taking the acoustic feedback cancellation unit 170 using the LMS algorithm as an example, based on the optimization method of gradient descent, the derivation of the above formula (1-2) can yield the following update formula for the prediction transfer function F′:

$${F}^{′} ← {F}^{′} + μ * e * {u}^{″} \qquad Formula ( 2 - 2 )$$

Where, μ is the iteration step size.

It should be understood that when the acoustic feedback cancellation unit 170 uses algorithms such as NLMS, RLS, etc., a similar method can be used to derive the update formula for the prediction transfer function F′. This disclosure does not provide examples for each case.

The acoustic system shown in FIG. 3A, after obtaining the target signal e, can have the signal processing circuit 150 perform the target operation on the target signal e. Continuing to refer to FIG. 3A, the signal processing circuit 150 can also include a gain amplification unit 152 (the gain amplification unit is labeled as G in FIG. 3A). The gain amplification unit 152 amplifies the target signal e and sends the amplified signal as the second audio signal u at the next moment to the first peripheral circuit 130, thereby driving the speaker 110 to produce sound.

As can be seen from the above, the acoustic system provided in this disclosure sets a reference signal pickup point 133 in the first peripheral circuit 130, and a second peripheral circuit 140 is arranged between the reference signal pickup point 133 and the signal processing circuit 150, so that the second peripheral circuit 140 can obtain the first reference signal u′ from the reference signal pickup point 133 and convert the first reference signal u′ into the second reference signal u″. As a result, the signal processing circuit 150 can apply the second reference signal u″ to the AFC technology, that is, the signal processing circuit 150 can reduce the feedback component in the first audio signal y based on the second reference signal u″ to obtain the target signal e. Since the feedback component in the target signal e is reduced or eliminated, it is possible to avoid or suppress acoustic system feedback and also help improve the maximum forward gain achievable by the acoustic system.

Since the acoustic feedback cancellation unit 151 can obtain the second reference signal u″ through the electrical space (i.e., the first peripheral circuit 130 and the second peripheral circuit 170) and use it for AFC technology, there is no need to obtain the second audio signal u from other units inside the signal processing circuit 150. Therefore, even in cases where access restrictions exist between different units inside the signal processing circuit 150, the acoustic system can still apply AFC technology to cancel the feedback components, thereby enhancing the applicability of AFC technology.

In the solution shown in FIG. 3A, after the signal processing circuit 150 obtains the second reference signal u″ from the electrical space, there is no need to change the internal implementation of the acoustic feedback cancellation unit 151, that is, there is no need to modify the update formula of the prediction transfer function F′ or the calculation formula for canceling the feedback components. Instead, it only requires replacing the input signal u of the acoustic feedback cancellation unit 151 with u″. As a result, it can be seen that the acoustic system shown in FIG. 3A can apply, adapt, and be compatible with the existing acoustic feedback cancellation unit 151, with a relatively low degree of modification difficulty and broad applicability.

Further, in some exemplary embodiments, at least one circuit element in the first processing component 134 exhibits a nonlinear response. The nonlinear response refers to the relationship between the output signal Sₒᵤₜ and the input signal Sin of the circuit element. If the output signal Sₒᵤₜ of circuit element A and the input signal Sin have a linear relationship, it indicates that circuit element A exhibits a linear response. If the output signal Sₒᵤₜ of circuit element A and the input signal Sin have a nonlinear relationship, it indicates that circuit element A exhibits a nonlinear response. For example, during the design phase of the acoustic system, one or more target elements in the first peripheral circuit 130 that exhibit a nonlinear response can be pre-studied. These target elements can be used as the first processing component 134, and the reference signal pickup point 130 can be set at a position after the first processing component 134.

In the solution shown in FIG. 3A, since the reference signal pickup point 133 is located after the first processing component 134, the prediction transfer function F′ actually fits the transfer characteristics of the second circuit part, the speaker 110, the spatial path between the speaker 110 and the sound sensor 120, and the transfer characteristics between the sound sensor 120 and the third peripheral circuit 140. Therefore, the prediction transfer function F′ no longer needs to fit the transfer characteristics of the first circuit part (i.e., the first processing component 134), which means that the nonlinear response of the first circuit part will not be introduced into the iterative solution of the prediction transfer function F′, reducing its impact on the convergence performance of the adaptive filtering algorithm, and thus improving the effect of eliminating the feedback components.

FIG. 7 shows the test results of the acoustic system provided in this disclosure in terms of filtering performance. Using the acoustic system shown in FIG. 3A as the test object, and referring to FIG. 7, when the first processing component 134 has a limited amplitude characteristic, the calculated mismatch (MIS) obtained using the scheme shown in FIG. 2 is represented by curve A. When the scheme shown in FIG. 3A is adopted, the calculated mismatch (MIS) is represented by curve B. The method of calculating the mismatch has been described earlier, and will not be repeated herein. In FIG. 7, curve B decreases more rapidly than curve A during the rapid convergence period, and maintains a faster average decrease during the steady convergence period. In other words, curve B remains below curve A throughout the entire shown time period. Therefore, the mismatch (MIS) in the scheme of FIG. 3A is always lower than in the scheme of FIG. 2, meaning that the scheme in FIG. 3A performs better in terms of both the convergence degree and convergence speed of the adaptive filtering algorithm. As shown in FIG. 7, the scheme in FIG. 3A significantly improves both the convergence degree and convergence speed of the adaptive filtering algorithm.

The signal processing circuit 150 can be configured to perform the signal processing methods described in the embodiments of this disclosure. In some exemplary embodiments, the signal processing circuit 150 may include multiple hardware circuits that are interconnected, with each hardware circuit comprising one or more electrical components that implement one or more steps of the signal processing method described in the embodiments of this disclosure during operation. For example, the acoustic feedback cancellation unit 151 and the gain amplification unit 152 can be implemented through different hardware circuits or different electrical components. These multiple hardware circuits can work together to implement the signal processing methods described in the embodiments of this disclosure. In some exemplary embodiments, the signal processing circuit 150 may also include hardware devices with data information processing capabilities and the necessary programs to drive the operation of these hardware devices. These hardware devices execute the programs to implement the signal processing methods described in the embodiments of this disclosure. The signal processing methods will be described in detail later in the document.

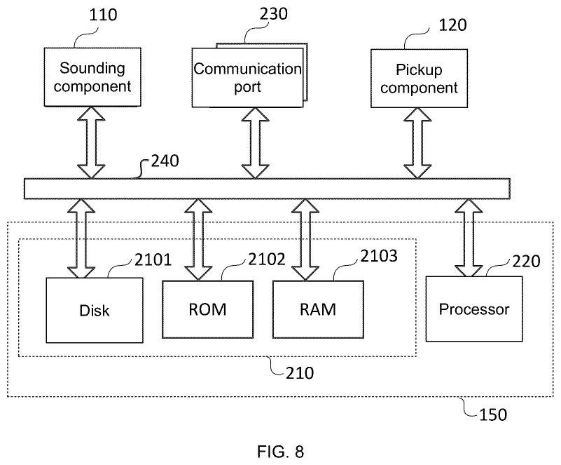

FIG. 8 is a schematic diagram of a hardware structure of the acoustic system provided in this disclosure. As shown in FIG. 8, the signal processing circuit 150 can include: at least one storage medium 210 and at least one processor 220. The at least one processor 220 is communicatively connected to the sounding component 10 and the pickup component 20. It should be noted that, for the sake of illustration, the signal processing circuit 150 in the embodiments of this disclosure includes at least one storage medium 210 and at least one processor 220. A person skilled in the art will understand that the signal processing circuit 150 can also include other hardware circuit structures, and the embodiments of this disclosure are not limited in this regard, as long as the structure can meet the functions mentioned in the embodiments of this disclosure without departing from the principles of the embodiments.

Continuing to refer to FIG. 8, in some exemplary embodiments, the acoustic system can also include a communication port 230. The communication port 230 is used for data communication between the acoustic system and the outside world. For example, the communication port 230 can be used for data communication between the acoustic system and other devices/systems. In some exemplary embodiments, the acoustic system can also include an internal communication bus 240. The internal communication bus 240 can connect different system components. For instance, the sounding component 10, the pickup component 20, the processor 220, the storage medium 210, and the communication port 230 can all be connected via the internal communication bus 240.

The storage medium 210 may include a data storage device. The data storage device can be a non-transitory storage medium or a transitory storage medium. For example, the data storage device may include one or more of a disk 2101, a read-only memory (ROM) 2102, or a random access memory (RAM) 2103. The storage medium 210 also includes at least one instruction set stored in the data storage device. The instruction set includes instructions, which are computer program code, and the computer program code may include programs, routines, objects, components, data structures, processes, modules, etc., that execute the signal processing methods provided in the embodiments of this disclosure.

The at least one processor 220 is used to execute the above-mentioned instruction set. When the acoustic system is operating, the at least one processor 220 reads the instruction set and, based on the instructions in the set, executes the signal processing methods provided in the embodiments of this disclosure. The processor 220 can execute all or part of the steps contained in the signal processing methods. The processor 220 may be in the form of one or more processors. In some exemplary embodiments, the processor 220 may include one or more hardware processors, such as a microcontroller, microprocessor, reduced instruction set computer (RISC), application-specific integrated circuit (ASIC), application-specific instruction set processor (ASIP), central processing unit (CPU), graphics processing unit (GPU), physical processing unit (PPU), microcontroller unit, digital signal processor (DSP), field-programmable gate array (FPGA), advanced RISC machine (ARM), programmable logic device (PLD), or any circuit or processor capable of performing one or more functions, or any combination thereof. For illustration purposes, the acoustic system shown in FIG. 8 illustrates the case where it includes only one processor 220. However, it should be noted that the acoustic system provided in the embodiments of this disclosure may also include multiple processors. Therefore, the operations and/or method steps disclosed in the embodiments of this disclosure may be executed by a single processor or jointly by multiple processors. For example, if the processor 220 of the acoustic system in the embodiments of this disclosure performs step A and step B, it should be understood that step A and step B may also be executed jointly or separately by two different processors 220 (e.g., the first processor performs step A, the second processor performs step B, or both the first and second processors jointly execute steps A and B).

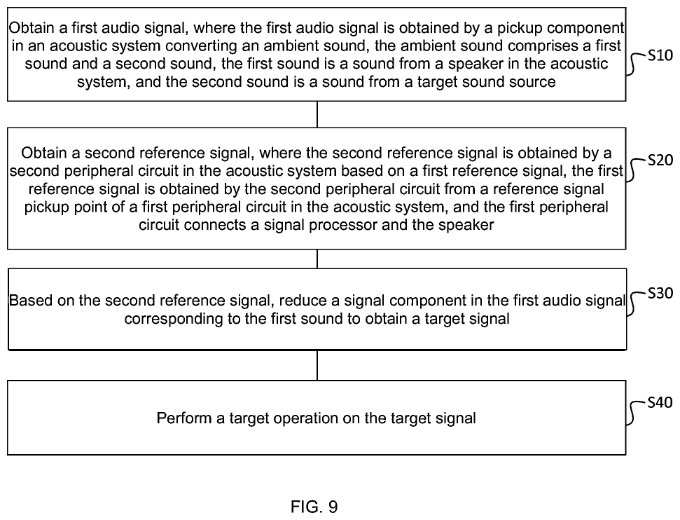

FIG. 9 is a flowchart of a signal processing method provided in some exemplary embodiments of this disclosure. As mentioned earlier, the signal processing circuit 150 in the acoustic system can execute the signal processing method P100 provided in this disclosure. Specifically, the processor 220 can read the instruction set stored in its local storage medium and then execute the signal processing method P100 according to the instructions. As shown in FIG. 9, the signal processing method P100 may include:

S10: Obtain a first audio signal, where the first audio signal is obtained by a pickup component in an acoustic system converting an ambient sound, the ambient sound comprises a first sound and a second sound, the first sound is a sound from a speaker in the acoustic system, and the second sound is a sound from a target sound source.

S20: Obtain a second reference signal, where the second reference signal is obtained by a second peripheral circuit in the acoustic system based on a first reference signal, the first reference signal is obtained by the second peripheral circuit from a reference signal pickup point of a first peripheral circuit in the acoustic system, and the first peripheral circuit connects a signal processor and the speaker.

It should be understood that the execution order of S10 and S20 can be arbitrary. For example, the signal processing circuit 150 can first execute S10 and then execute S20, or first execute S20 and then execute S10, or even execute S10 and S20 in parallel.

S30: Based on the second reference signal, reduce a signal component in the first audio signal corresponding to the first sound to obtain a target signal.

S40: Perform a target operation on the target signal.

In some exemplary embodiments, the type of the first reference signal includes at least one of an analog signal, a pulse width modulation (PWM) signal, a pulse density modulation (PDM) signal, a pulse code modulation (PCM) signal, an integrated circuit built-in audio I2S signal, or a time-division multiplexing (TDM) signal.

In some exemplary embodiments, the process of reducing the signal components corresponding to the first sound in the first audio signal based on the second reference signal to obtain the target signal includes: performing an adaptive filtering operation on the second reference signal to obtain a filtered signal; and subtracting the filtered signal from the first audio signal to obtain the target signal.

In some exemplary embodiments, the method further includes: updating the filtering parameters corresponding to the adaptive filtering operation based on at least one of the target signal and the second reference signal.

It should be noted that the detailed implementation of the signal processing method P100 can be referred to in the relevant descriptions of the acoustic system mentioned earlier. The underlying principles and technical effects are similar, and will not be repeated herein.

In summary, in the solutions provided in this disclosure, the acoustic system sets the reference signal pickup point 133 in the first peripheral circuit 130 and places the second peripheral circuit 140 between the reference signal pickup point 133 and the signal processing circuit 150, so that the second peripheral circuit 140 can obtain the first reference signal u′ from the reference signal pickup point 133 and convert it into the second reference signal u″. As a result, the signal processing circuit 150 can apply the second reference signal u″ to AFC technology, meaning that the signal processing circuit 150 can reduce the feedback components in the first audio signal y based on the second reference signal u″ to obtain the target signal e. Since the feedback components in the target signal e are reduced or eliminated, this can avoid or suppress the occurrence of acoustic feedback and also help enhance the maximum forward gain that the acoustic system can achieve.

This disclosure also provides a non-transitory storage medium that stores at least one set of executable instructions for signal processing. When the executable instructions are executed by a processor, the instructions guide the processor to perform the steps of the signal processing method P100 described in this document. In some possible implementations, the various aspects of this document may also be implemented in the form of a program product that includes program code. When this program product runs on an acoustic system, the program code enables the acoustic system to perform the steps of the signal processing method P100 described in this document. The program product used to implement the above method may be in the form of a portable compact disc read-only memory (CD-ROM) that includes program code, and it can run on the acoustic system. However, the program product in this document is not limited to this, as the readable storage medium can be any tangible medium that contains or stores the program, which can be used or combined with an instruction-execution system. The program product can be composed of one or more readable media in any combination. A readable medium can be either a readable signal medium or a readable storage medium. A readable storage medium may include, but is not limited to, electric, magnetic, optical, electromagnetic, infrared, or semiconductor systems, devices, or components, or any combination of these. More specific examples of readable storage media include: electric connections with one or more wires, portable disks, hard drives, random-access memory (RAM), read-only memory (ROM), erasable programmable read-only memory (EPROM or flash memory), optical fibers, portable compact disc read-only memories (CD-ROMs), optical storage devices, magnetic storage devices, or any suitable combination thereof. The computer-readable storage medium may include data signals that are propagated as part of a carrier, in which the readable program code is carried. Such propagated data signals can take various forms, including but not limited to electromagnetic signals, optical signals, or any suitable combination thereof. A readable storage medium can also be any readable medium other than a readable storage medium, which can transmit, propagate, or transport programs for use or in combination with an instruction-execution system, device, or apparatus. The program code contained on the readable storage medium can be transmitted through any appropriate medium, including but not limited to wireless, wired, optical fiber, RF, or any suitable combination thereof. The program code can be written in any combination of one or more programming languages, including object-oriented programming languages such as Java, C++, etc., and conventional procedural programming languages such as C or similar languages. The program code can be fully executed on the acoustic system, partially executed on the acoustic system, executed as an independent software package, partially executed on the acoustic system and partially on a remote computing device, or fully executed on a remote computing device.

The above description pertains to specific embodiments of the present disclosure. Other embodiments are within the scope of the appended claims. In some cases, the actions or steps described in the claims can be performed in a sequence different from the one in the embodiments and still achieve the desired result. Additionally, the processes depicted in the drawings do not necessarily require a specific order or continuous sequence to achieve the desired outcome. In certain embodiments, multitasking and parallel processing are also possible or may be beneficial.

In summary, after reading this detailed disclosure, a person skilled in the art can understand that the aforementioned detailed disclosure is presented only by way of example and is not intended to be limiting. Although not explicitly stated here, a person skilled in the art will appreciate that the disclosure encompasses various reasonable alterations, improvements, and modifications to the embodiments. These alterations, improvements, and modifications are intended to be within the spirit and scope of the exemplary embodiments presented in this disclosure.

In addition, certain terms in this disclosure have been used to describe the embodiments of the disclosure. For example, the terms “one embodiment,” “embodiment,” and/or “some exemplary embodiments” mean that specific features, structures, or characteristics described in connection with that embodiment may be included in at least one embodiment of the disclosure. Therefore, it should be emphasized and understood that references to “embodiment,” “one embodiment,” or “alternative embodiment” in various parts of this disclosure do not necessarily refer to the same embodiment. Additionally, specific features, structures, or characteristics may be appropriately combined in one or more embodiments of the disclosure.

It should be understood that in the foregoing description of the embodiments of the disclosure, in order to aid in understanding a feature and simplify the presentation, various features are combined in a single embodiment, drawing, or description. However, this does not mean that the combination of these features is required. A person skilled in the art, upon reading this disclosure, could very well consider part of the equipment marked as a separate embodiment. In other words, the embodiments in this disclosure can also be understood as the integration of multiple sub-embodiments. And each sub-embodiment is valid even when it includes fewer features than a single full embodiment disclosed above.

Each patent, patent application, publication of a patent application, and other materials, such as articles, books, disclosures, publications, documents, articles, etc., cited herein, except for any historical prosecution documents to which it relates, which may be inconsistent with or any identities that conflict, or any identities that may have a restrictive effect on the broadest scope of the claims, are hereby incorporated by reference for all purposes now or hereafter associated with this document. Furthermore, in the event of any inconsistency or conflict between the description, definition, and/or use of a term associated with any contained material, the term used in this document shall prevail.

Finally, it should be understood that the embodiments of the application disclosed herein are illustrative of the principles of the embodiments of this disclosure. Other modified embodiments are also within the scope of this disclosure. Therefore, the embodiments disclosed in this disclosure are merely examples and not limitations. A person skilled in the art can adopt alternative configurations based on the embodiments in this disclosure to implement the application in this disclosure. Thus, the embodiments of this disclosure are not limited to the embodiments described in the application in precise detail.

What is claimed is:

1. An acoustic system, comprising:
a speaker, configured to convert a driving signal into a first sound during operation;
a pickup component, configured to convert an ambient sound into a first audio signal during operation, the ambient sound comprising the first sound and a second sound from a target sound source;
a signal processing circuit, connected to the pickup component;
a first peripheral circuit, comprising an input port and an output port, the output port being connected to the speaker, the first peripheral circuit comprising a reference signal pickup point; and
a second peripheral circuit, connecting the reference signal pickup point and the signal processing circuit, wherein
the first peripheral circuit, during operation, obtains a second audio signal through the input port, converts the second audio signal into the driving signal, and sends the driving signal to the speaker through the output port,
the second peripheral circuit, during operation, obtains a first reference signal from the reference signal pickup point and outputs a second reference signal to the signal processing circuit; and
the signal processing circuit, during operation, reduces a signal component corresponding to the first sound in the first audio signal based on the second reference signal to obtain a target signal, and performs a target operation on the target signal.

2. The acoustic system according to claim 1, wherein the first reference signal comprises at least one of an analog signal, a pulse width modulation (PWM) signal, a pulse density modulation (PDM) signal, a pulse code modulation (PCM) signal, an integrated circuit built-in audio I2S signal, or a time-division multiplexing (TDM) signal.

3. The acoustic system according to claim 1, wherein the reference signal pickup point is located at the input port; or
the reference signal pickup point is located at the output port.

4. The acoustic system according to claim 1, wherein
the first peripheral circuit further comprises a first processing component, the first processing component is connected to the signal processing circuit via the input port, and during operation, obtains the second audio signal from the signal processing circuit and performs at least one of a digital-to-analog conversion operation, a modulation operation, or a filtering operation on the second audio signal; and
the reference signal pickup point is located between the first processing component and the output port.

5. The acoustic system according to claim 4, wherein
the first peripheral circuit further comprises a second processing component connected between the first processing component and the output port, wherein
the reference signal pickup point is located between the first processing component and the second processing component, or the reference signal pickup point is located between the second processing component and the output port, or the second processing component comprises a plurality of circuit elements, and the reference signal pickup point is located between any two of the plurality of circuit elements.

6. The acoustic system according to claim 4, wherein the second audio signal comes from the target signal.

7. The acoustic system according to claim 4, wherein the second audio signal comprises a first signal component and a second signal component,
the first signal component comes from the target signal, and
the second signal component comes from a target audio component, and the target audio component is different from the pickup component.

8. The acoustic system according to claim 1, wherein the input port comprises K branch ports, wherein K is an integer greater than 1;
the second audio signal comprises K branch audio signals; and
the first peripheral circuit obtains the K branch audio signals through the K branch ports and converts the K branch audio signals into the driving signal.

9. The acoustic system according to claim 8, wherein
the first peripheral circuit further comprises a third processing component, during operation, the third processing component performs at least one of a digital-to-analog conversion operation, a modulation operation, a filtering operation, or a mixing operation on the K branch audio signals; and
the reference signal pickup point is located between the third processing component and the output port.

10. The acoustic system according to claim 8, wherein
the first peripheral circuit further comprises:
K branch processing components, respectively connected to the K branch ports, wherein during operation, an i-th branch processing component performs at least one of a digital-to-analog conversion operation, a modulation operation, or a filtering operation on an i-th branch audio signal to obtain an i-th intermediate audio signal, and
a first mixing component, connected to K third processing components, wherein during operation, the first mixing component performs a mixing operation on K intermediate audio signals; and
the reference signal pickup point is located between the first mixing component and the output port.

11. The acoustic system according to claim 8, wherein
the first peripheral circuit further comprises:
a second mixing component, connected to the K branch ports, wherein during operation, the second mixing component performs a mixing operation on the K branch audio signals to obtain a mixed audio signal, and
a fourth processing component, connected to the second mixing component, wherein during operation, the fourth processing component performs at least one of a digital-to-analog conversion operation, a modulation operation, or a filtering operation on the mixed audio signal; and
the reference signal pickup point is located between the second mixing component and the fourth processing component, or the reference signal pickup point is located between the fourth processing component and the output port.

12. The acoustic system according to claim 8, wherein the branch audio signals obtained by the first peripheral circuit through the K branch ports all come from the target signal.

13. The acoustic system according to claim 8, wherein the K branch ports comprise a first subset of branch ports and a second subset of branch ports;
branch audio signals obtained by the first peripheral circuit through the first subset of branch ports come from the target signal; and
branch audio signals obtained by the first peripheral circuit through the second subset of branch ports come from a target audio component, and the target audio component is different from the pickup component.

14. The acoustic system according to claim 1, wherein the second peripheral circuit, during operation, performs at least one of an analog-to-digital conversion operation, a demodulation operation, a filtering operation, or a gain operation on the first reference signal to obtain the second reference signal.

15. The acoustic system according to claim 1, wherein to obtain the target signal, the signal processing circuit is further configured to:
perform an adaptive filtering operation on the second reference signal to obtain a filtered signal; and
subtract the filtered signal from the first audio signal to obtain the target signal.

16. The acoustic system according to claim 15, wherein the signal processing circuit is further configured to:
update filtering parameters corresponding to the adaptive filtering operation based on at least one of the target signal or the second reference signal.

17. The acoustic system according to claim 1, wherein when performing the target operation, the signal processing circuit performs:
executing a gain amplification operation on the target signal to obtain an amplified signal; and
sending the amplified signal to the first peripheral circuit.

18. The acoustic system according to claim 1, wherein the pickup component comprises a sound sensor and a third peripheral circuit;
the sound sensor, during operation, converts the ambient sound into a pickup signal, and
the third peripheral circuit, during operation, converts the pickup signal into the first audio signal.

19. The acoustic system according to claim 1, wherein the signal processing circuit comprises:
at least one storage medium, storing at least one instruction set for signal processing; and
at least one processor, communicatively connected with the first peripheral circuit, the second peripheral circuit, the pickup component and the at least one storage medium, wherein, when the acoustic system is operating, the at least one processor reads the at least one instruction set and executes, based on the at least one instruction set:
reducing the signal component corresponding to the first sound in the first audio signal based on the second reference signal to obtain the target signal, and performing the target operation on the target signal.

20. A signal processing method, comprising, by a signal processing circuit in an acoustic system:
obtaining a first audio signal, wherein the first audio signal is obtained by a pickup component in the acoustic system converting an ambient sound, the ambient sound comprises the first sound and a second sound, the first sound is a sound from a speaker in the acoustic system, and the second sound is a sound from a target sound source;
obtaining a second reference signal, wherein the second reference signal is obtained by a second peripheral circuit in the acoustic system based on a first reference signal, the first reference signal is obtained by the second peripheral circuit from a reference signal pickup point of a first peripheral circuit in the acoustic system, and the first peripheral circuit is connected to the processing circuit and the speaker;
reducing a signal component corresponding to the first sound in the first audio signal based on the second reference signal to obtain a target signal; and
performing a target operation on the target signal.
